(19) United States
(12) Patent Application Publication
(10) Pub. No.: US 2017/0261229 A1
(43) Pub. Date: Sep. 14, 2017

(54) AUTONOMOUS ENERGY SAVING DEVICE FOR WATER HEATERS

(71) Applicant: COTHERM, VINAY (FR)

(72) Inventor: Cedric MONNERON, LYON (FR)

(21) Appl. No.: 15/088,381

(22) Filed: Apr. 1, 2016

(30) Foreign Application Priority Data
Mar. 14, 2016 (FR) 1652132

(51) Int. Cl. F24H 1/20; G05B 15/02; F24H 9/20

(52) U.S. Cl. CPC F24H 1/201; F24H 9/2021; G05B 15/02

(57) ABSTRACT

The autonomous energy saving device (2) enabling the control of a water heater (1) connected to a power grid comprising a phase P, a neutral N and a protective conductor T operating on a permanent power supply or during rate periods using a switch or timer, said energy saving device (2) comprises inputs E1, E2, E3 and the outputs S1, S2, S3 and between inputs E1 and E2 and the outputs S1 and S2 at least one primary circuit board (7) comprising at least one electronic component (3, 4) and a control algorithm to remove or reduce the heating times of the water heater (1) without changing the technical characteristics of the water heater, and in order to adapt its operation to the needs of the user.

### FIELD OF THE INVENTION

This invention concerns an autonomous energy-saving device allowing automatic programming of a dumb electrical device like an electric water heater, continuously connected to the grid or operating on rate periods using a switch or timer.

### BACKGROUND OF THE INVENTION

In general, a dumb electric water heater comprises a thermostat provided with a temperature sensor which is integrated in the water heater and that makes it possible to measure the temperature of the water in the water heater tank.

The so-called “smart” electronic thermostats for water heaters are known which include learning functions and that run heating programs at various times and at different heating temperatures.

These so-called “smart” electronic thermostats always include a temperature sensor that must be mounted on the dumb electric water heater to replace the one provided by the manufacturer. These so-called “smart” electronic thermostats can alter the water heater's technical characteristics and cause malfunctions which are not guaranteed by the manufacturer.

Mechanical or electronic programmers are also known that allow the customer to set fixed times for turning on the dumb electric water heater. These mechanical or electronic programmers are installed on the main power source to the water heater, but do not save the household consumption patterns in order to reduce electricity consumption.

### SUMMARY OF THE INVENTION

The object of this invention is an autonomous energy saving device which is positioned on the supply line of a dumb water heater making it possible to automatically program it to learn the home routines, and which is installed upon the water heater to make it smart without having to change the water heater and therefore eliminate the risk of damaging or changing the characteristics of the safety controls of said water heater equipped with the energy saving device.

The autonomous energy saving device of this invention makes it possible to take control of an electric heater connected to the grid with a phase P, a neutral N and a protective conductor T that operate with a permanent power supply or during rate periods using a switch or timer. The autonomous energy saving device according to this invention includes inputs E1, E2, E3 and outputs S1, S2, S3 and between the inputs E1 and E2 and the outputs S1 and S2 at least one electronic component to remove or reduce the water heater's heating times without changing the technical characteristics of the water heater, in order to adapt its operation to the actual needs of the user.

The autonomous energy saving device making it possible to control a water heater according to this invention comprising at least one temperature sensor mounted on the water inlet or outlet of the water heater.

The autonomous energy saving electronic component making it possible to control a water heater according to this invention comprising at least one current sensor making it possible to identify the operating state of the water heater's thermostat.

The autonomous energy saving electronic component making it possible to control a water heater according to this invention comprising at least one controlled relay to reduce the heating times of the water heater.

The autonomous energy saving device making it possible to control a water heater according to this invention comprising at least one flow rate sensor mounted on the inlet or outlet of the water heater.

The autonomous energy saving device making it possible to control a water heater according to this invention comprising at least one means of communication with external management supports connected to the internet by means of an internal or external network.

The autonomous energy saving device making it possible to control a water heater according to this invention comprising at least one electronic component comprising a microcontroller for storing measurement logs.

The autonomous energy saving device making it possible to control a water heater according to this invention comprising at least one electronic component comprising a microcontroller connected to a component for storing measurement logs.

The autonomous energy saving device making it possible to control a water heater according to this invention constituted of a housing linked to the main power supply of the water heater, with a means to connect to attach the primary circuit board comprising at least one electronic component and a control algorithm to remove or reduce the duration of the water heater's heating periods and a protective conductor that is attached to said housing.

The autonomous energy saving device making it possible to control a water heater according to this invention comprises a housing, the protective cover of which includes a window for passage of an indicator light placed on the primary circuit board.

The autonomous energy saving device making it possible to control a water heater according to this invention comprises a housing provided with a first side opening for connection to the primary circuit board by means of a wire connecting the latter to at least one temperature sensor mounted on the cold water inlet or on the hot water outlet of the water heater.

The autonomous energy saving device making it possible to control a water heater according to this invention comprises a housing provided with a second side opening for connection to the primary circuit board of the power cable, connecting the latter to the water heater.

The autonomous energy saving device making it possible to control a water heater according to this invention comprises a housing provided with a third side opening for connection to the primary circuit board by means of a wire connecting the latter to at least one flow rate sensor mounted on the cold water inlet or on the hot water outlet of the water heater.

### BRIEF DESCRIPTION OF DRAWINGS

The description that follows with regard to the attached drawings, given as non-limiting examples, will make it possible to better understand the invention, the characteristics which it presents and the advantages which are likely to be obtained:

FIGS. 1 and 2 are views showing the installation of the autonomous energy saving device according to this invention on a per se known water heater.

FIG. 3 is an exploded view in perspective depicting the housing of the autonomous energy saving device according to this invention.

FIG. 4 is a schematic view depicting the electrical connection of the autonomous energy saving device according to this invention.

FIG. 5 is a schematic view depicting the electrical connection of the autonomous energy saving device according to this invention on the electrical circuit of a water heater.

### DETAILED DESCRIPTION OF THE INVENTION

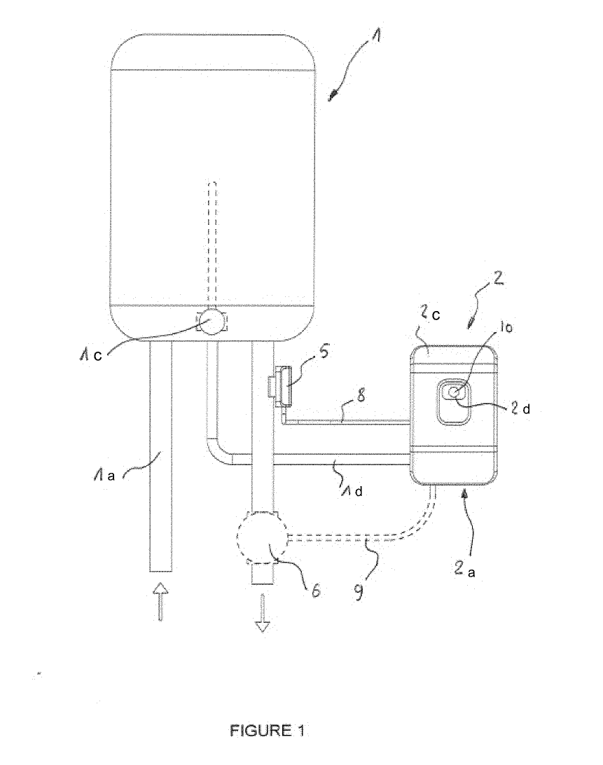

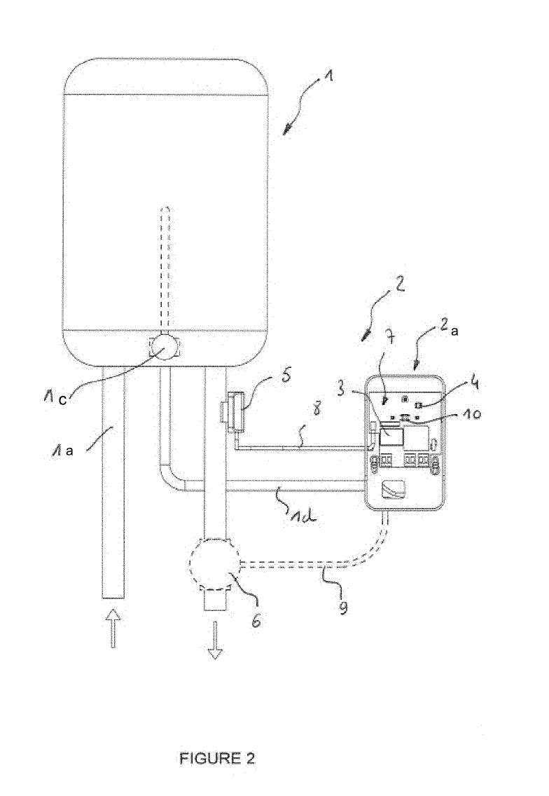

FIGS. 1 and 2 show a water heater 1 that is known is per se connected to a cold water supply pipe 1a and a hot water outlet pipe 1b. The water heater 1 comprises a control thermostat 1c which is connected via an electrical cable 1d to the general power supply.

The thermostat 1c makes it possible to control and regulate the temperature of the water inside the tank of the water heater 1. The regulating thermostat 1c controls the power of the electrical resistance, cutting it off when the water in the tank has reached the desired temperature, or powering it up if the hot water has been extracted from the tank and/or if the tank water has become cold.

The autonomous energy saving device 2 according to this invention is mounted directly on the main power supply upstream of the thermostat 1c of the water heater 1.

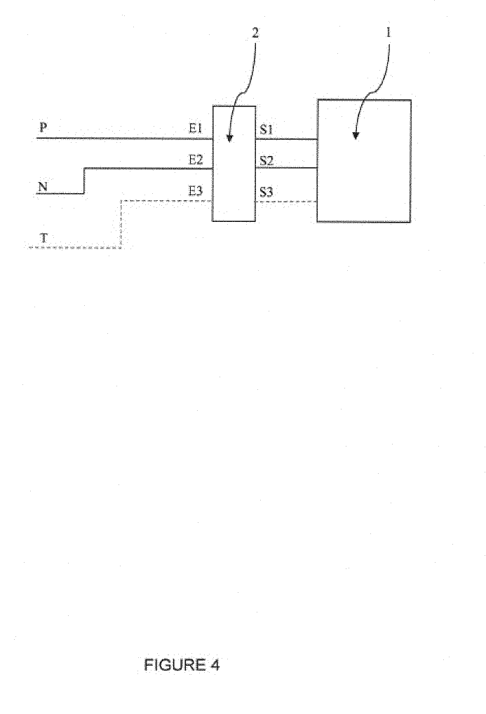

The autonomous energy saving device 2 includes connections consisting of screw type or spring connectors or “plug connectors” forming the inputs E1, E2, E3 and the outputs S1, S2, S3 of said energy saving device (FIG. 4).

The autonomous energy saving device 2 includes inputs E1, E2, E3 and outputs S1, S2, S3 and between at least one of inputs E1 or E2 and outputs S1 or S2 to at least one primary circuit board 7 comprising at least one electronic component 3, 4 and a control algorithm for controlling the power supply to the water heater 1 connected downstream of the device.

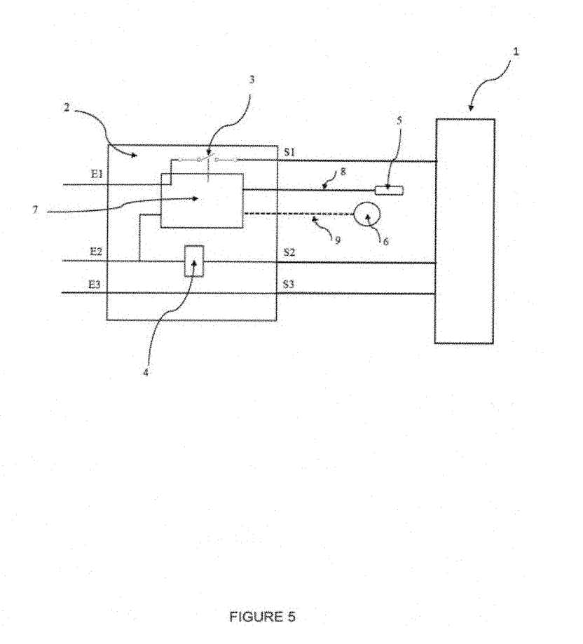

An example of an electrical connection of the autonomous energy saving device 2 between the power supply of the housing installation E1, E2, E3 and the outputs S1, S2, S3 of the water heater 1 is illustrated in FIG. 5.

In this case, the autonomous energy saving device 2 comprises between the input E1 and the output S1, the first electronic component 3 of the primary circuit board 7 ensuring a function type switch or relay which is connected via the input E1 to phase P of electrical supply and through the output S1 to the water heater 1.

The first electronic switch or relay type component 3 provides electrical current to the water heater 1 according to the power periods controlled by the algorithm of the primary circuit board 7 of the autonomous energy saving device 2

The second input E2 is connected directly to the second output S2 of the water heater 1 but upon which the second electronic component 4 of the primary circuit board 7 is connected to the autonomous energy saving device 2 in order to detect the current circulating in the connection depending upon the state of the thermostat 1c and thus making it possible to inform the algorithm (of the primary circuit board 7 of the autonomous energy saving device 2) of the power supply periods in the water heater 1.

The third input E3 is directly connected to the output S3 of the autonomous energy saving device 2.

Other solutions may be provided for the electric connections and positioning of the electronic components 3 and 4 between the inputs E1, E2 and the outputs S1, S2 without that changing the operation of the autonomous energy saving device 2.

The second electronic component 4 is constituted by at least one current sensor making it possible to identify the operating state of the thermostat 1c of the water heater 1. The current sensor 4 makes it possible to identify the heating periods of the thermostat 1c and the power consumption of the water heater 1. The current sensor 4 may also allow the detection or presence of calcium carbonate deposits in the water heater 1.

The current sensor 4 makes it possible to send, based on the readings from the current circulating in the connection, and save such information to the control algorithm of the primary circuit board 7 of the autonomous energy saving device 2 to analyze the water heater 1 user consumption profiles and also to measure and record electrical consumption of said water heater.

The autonomous energy saving device 2 may include at least one temperature sensor 5 which is placed either on the cold water inlet pipe 1a or on the hot water outlet pipe 1b of the water heater 1. The temperature sensor 5 can be mounted in any area of the installation. Either close to the water heater 1 or remotely without changing the operation of the autonomous energy saving device 2.

The temperature sensor 5 makes it possible to identify the schedules of water extraction by the user and the detection of a presence makes it possible to determine the schedules of cold or hot water consumption by the user.

The temperature sensor 5 is connected by a wire 8 to the primary circuit board 7 of the autonomous energy saving device 2 to record the times when water is extracted and the consumption schedules of cold or hot water used by the user to compare them to the information from the current sensor 4 to refine the water heater user consumption profiles 1.

The autonomous energy saving device 2 may include at least one flow rate sensor 6 that is positioned on the cold water inlet 1a or on the hot water outlet 1b of the water heater 1. The flow rate sensor 6 makes it possible to identify the amount of cold water feeding the water heater 1 or the amount of hot water extracted from said water heater.

The flow rate sensor 6 is connected by a wire 9 to the primary circuit board 7 of the autonomous energy saving device 2 to record the amounts of cold water or hot water consumed by the user to compare them to the information from the current sensor 4 and/or from the temperature sensor 5 to refine the water heater user consumption profiles 1.

The primary circuit board 7 of the autonomous energy saving device 2 comprises at least one electronic component consisting of a microcontroller or of a microprocessor connected to a component allowing for storage of measurement logs coming from the switch 3, of the current sensor 4, and/or from the temperature sensor 5 and/or from the flow rate sensor 6.

The control algorithm of primary circuit board 7 of the autonomous energy saving device 2 can also be set by the user depending upon the characteristics of the water heater 1, the dimensions of the tank, and the level of comfort sought.

The control algorithm of the primary circuit board 7 allows using one part of the information obtained by the current sensor 4, and/or from the temperature sensor 5 and/or from the flow rate sensor 6 and from the other settings from the technical characteristics of the water heater 1 to control the switch or relay 3 to reduce the heating times of said water heater.

The autonomous energy saving device 2 may comprise a second circuit board or a second component allowing communication with external management supports connected to the internet by means of an internal or external network.

The means of communication may be constituted by an electronic circuit for communicating through different protocols and communication media known to date such as WIFI, Bluetooth, Powerline, UNB (Ultra Narrow Band), LoRaWAN (Long Range Wide-area network which may be translated as “long-range WAN”).

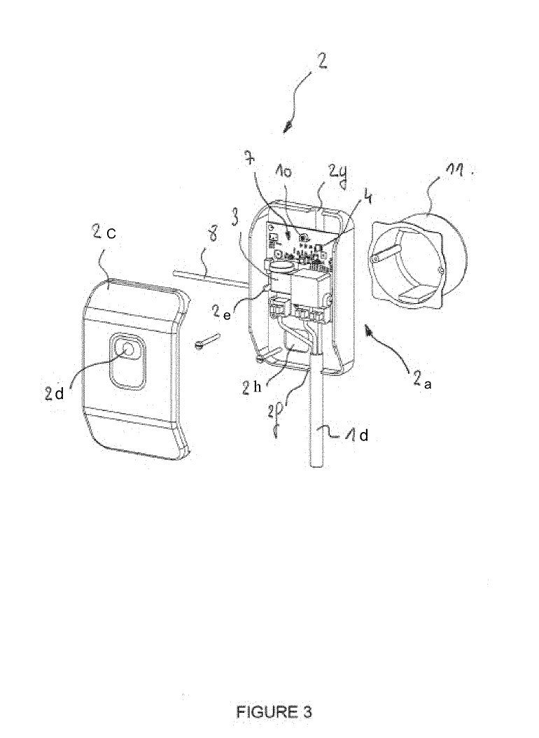

In FIG. 3 the autonomous power saving device 2 is shown which consists of a housing 2a which is fixed and connected to the recessed housing 11 of the main power supply of the water heater 1. The housing 2a may alternatively be wall mounted and not directly mounted upon the recessed housing 11.

The housing 2a comprises a means of connection, not shown, allowing the attachment of the primary circuit board 7 provided with at least one electronic component 3, 4 and a control algorithm which makes it possible to remove or reduce the heating times of the water heater 1.

The housing 2a is closed with a protective cover 2c. The protective cover 2c includes a window 2d which allows for passage of an indicator light 10 placed on the primary circuit board 7.

The housing 2a has a first side opening 2e making it possible to connect the primary circuit board 7 with a wire 8 connecting the latter to at least one temperature sensor 5 mounted on either the cold water inlet 1a or on the hot water outlet 1b of the water heater 1.

The housing 2a has a second side opening 2f making it possible to connect the primary circuit board 7 with the power cable 1d, connecting the latter to the water heater 1.

The housing 2a has a third side opening 2g making it possible to connect the primary circuit board 7 with another wire 9 connecting the latter to at least one flow rate sensor 6 mounted on either the cold water inlet 1a or on the hot water outlet 1b of the water heater 1.

The bottom of the housing 2a comprises a window 2h allowing the passage of electrical supply cables from the recessed housing 11.

Note that the autonomous energy saving device 2 according to this invention supplies power to the water heater 1 only if heating water is required from a user's consumption history or according to an operating stage selected by the user.

It should be understood that the above description was given only as an example and by no means limits the field of the invention, nor will it be outside the field of the invention, if implementation details described are replaced with any other equivalent.

1. Autonomous energy saving device (2) enabling the control of a water heater (1) connected to a power grid comprising a phase P, a neutral N and a protective conductor T operating on a permanent power supply or during rate periods using a switch or timer, wherein the device includes inputs E1, E2, E3 and outputs S1, S2, S3 and between the inputs E1 and E2 and the outputs S1 and S2, at least one primary circuit board (7) comprising at least one electronic component (3, 4) and a control algorithm to remove or reduce the heating times of the water heater (1) without changing the technical characteristics of the water heater, and in order to adapt its operation to the needs of the user.

2. The autonomous energy saving device (2) making it possible to control a water heater (1) according to claim 1, wherein the first electronic component comprises at least one control switch or a relay (3) for reducing the heating times of the water heater (1).

3. The autonomous energy saving device (2) making it possible to control a water heater (1) according to claim 1, wherein the second electronic component is constituted by at least one current sensor (4) making it possible to identify the operating state of the thermostat of the water heater (1).

4. The autonomous energy saving device (2) making it possible to control a water heater (1) according to claim 1, further comprising at least one temperature sensor (5) mounted on either the cold water inlet (1a) or on the hot water outlet (1b) of the water heater (1).

5. The autonomous energy saving device (2) making it possible to control a water heater (1) according to claim 1, further comprising at least one flow rate sensor (6) mounted on either the cold water inlet (1a) or on the hot water outlet (1b) of the water heater (1).

6. The autonomous energy saving device (2) making it possible to control a water heater (1) according to claim 1, further comprising a second circuit board or second component allowing communication with external management supports connected to the internet by means of an internal or external network.

7. The autonomous energy saving device (2) making it possible to control a water heater (1) according to claim 1, wherein the primary circuit board (7) comprises at least one electronic component consisting of a microcontroller enabling storage of the measurement logs.

8. The autonomous energy saving device (2) making it possible to control a water heater (1) according to claim 1, wherein the primary circuit board (7) comprises at least one electronic component consisting of a microcontroller connected to a component enabling storage of the measurement logs.

9. The autonomous energy saving device (2) making it possible to control a water heater (1) according to claim 1, wherein the device comprises a housing (2a) linked to the main power supply of the water heater (1), with a means to connect to attach the primary circuit board (7) comprising at least one electronic component (3, 4) and a control algorithm which makes it possible to remove or reduce the heating times of the water heater (1) and a protective cover (2c) attached to said housing (2a).

10. The autonomous energy saving device (2) making it possible to control a water heater (1) according to claim 9, wherein the protective cover (2c) includes a window (2d) which allows for passage of an indicator light (10) placed on the primary circuit board (7).

11. The autonomous energy saving device (2) making it possible to control a water heater (1) according to claim 9, wherein the housing (2a) has a second side opening (2e) making it possible to connect the primary circuit board (7) with a wire (8) connecting the latter to at least one temperature sensor (5) mounted on either the cold water inlet (1a) or on the hot water outlet (1b) of the water heater (1).

12. The autonomous energy saving device (2) making it possible to control a water heater (1) according to claim 9, wherein the housing (2a) has a second side opening (2f) making it possible to connect the primary circuit board (7) with the power cable (1d), connecting the latter to the water heater (1).

13. The autonomous energy saving device (2) making it possible to control a water heater (1) according to claim 9, wherein the housing (2a) has a third side opening (2g) making it possible to connect the primary circuit board (7) with another wire (9) connecting the latter to at least one flow rate sensor (6) mounted on either the cold water inlet (1a) or on the hot water outlet (1b) of the water heater (1).
